(19) United States
(12) Patent Application Publication
(10) Pub. No.: US 2002/0092692 A1
(43) Pub. Date: Jul. 18, 2002

(54) CRUISE CONTROL DEVICE OF ELECTRIC SCOOTER

(75) Inventor: Tsang-Ying Chen, Chang Hua Hsien (TW)

Correspondence Address: BROWDY AND NEIMARK, P.L.L.C., 624 NINTH STREET, NW, SUITE 300, WASHINGTON, DC, 20001-5303, US

(73) Assignee: MELTON INTERNATIONAL L.L.C., Dover, DE (US)

(21) Appl. No.: 09/781,407

(22) Filed: Feb. 13, 2001

(30) Foreign Application Priority Data
Jan. 12, 2001 (TW) 90200622

(51) Int. Cl. B62K 11/00

(52) U.S. Cl. 180/220; 180/205; 180/170; 180/65.1

(57) ABSTRACT

A cruise control device of an electric scooter comprises a power unit, a joining member, and a retaining member. The power unit is mounted near the rear wheel of the scooter and is formed of a motor having an output shaft on which a drive wheel is mounted. The joining member is fastened with the power unit and has a joining portion. The retaining member is pivoted with the scooter rear fork and is provided at one end with an actuating portion connected with a steel cable, and at other end with a retaining portion engageable with the joining portion so as to cause the drive wheel to drive the rear wheel at a constant speed. As the steel cable is triggered, the actuating portion of the retaining member is caused to swivel, thereby resulting in disengagement of the retaining portion with the joining portion. The drive wheel thus moves away from the scooter rear wheel.

### FIELD OF THE INVENTION

The present invention relates generally to a scooter, and more particularly to a cruise control of an electric scooter.

### BACKGROUND OF THE INVENTION

The conventional electric scooter is provided with a motor to drive the rear wheel of the scooter. In order to keep the speed of the scooter at a constant speed, the rider of the scooter must keep treading a suspension seat so as to enable the motor output shaft to join with the rear wheel.

As shown in FIG. 1, a prior art electric scooter 90 is provided with an urging member 94 which is mounted on the rear fork 95 to control the engagement and the disengagement of the rear wheel 93 with the output shaft 92 of the motor 91. The urging member 94 has two slots 941 and 942. The suspension seat 96 has a protruded portion 961, which is inserted into the slot 941 to enable the suspension seat 96 to be urged by the urging member 94. The output shaft 92 is not in contact with the rear wheel 93. The scooter is thus operated by foot. When the protruded block 961 is inserted into the second slot 942, the suspension seat 96 is caused by its own weight and the tensile of the spring 97 to enable the output shaft 92 to engage the rear wheel 93, which is thus turned to move the scooter forward. The urging member 94 is manually operated at the time when the scooter is stationary.

### SUMMARY OF THE INVENTION

The primary objective of the present invention is to provide an electric scooter with a cruise control free of the mechanical deficiencies of the prior art scooters described above.

The cruise control of the present invention comprises a power unit, a joining member, and a retaining member. The power unit has a suspension seat which is pivoted at one end with the bottom board in proximity of the rear wheel, a motor mounted on the suspension seat, and a drive wheel mounted on a motor output shaft to engage the rear wheel. The suspension seat is acted on by a spring to enable the drive wheel to separate from the rear wheel by a distance. The joining member is mounted at one end on the power unit and is provided at other end with a joining portion. The retaining portion is pivoted at the midsegment with the rear fork of the scooter and is provided at one end with an actuating portion which is fastened with a steel cable of the grip for causing the midsection of the actuating portion to swivel on its axis. The retaining member is acted on by a spring to return to its original position when it is relieved of the action of the steel cable. The retaining member is provided at one end with a retaining portion opposite to the actuating portion to engage the joining portion of the joining member.

As the suspension seat is pressed, the joining portion is engaged with the retaining portion, thereby causing the rear wheel to be driven by the drive wheel at a constant speed. As the steel cable is pulled, the actuating portion is swiveled such that the retaining portion is disengaged with joining portion. As a result, the drive wheel is disengaged with the rear wheel.

### BRIEF DESCRIPTION OF THE DRAWINGS

FIG. 1 shows a schematic view of a prior art scooter in action.

FIG. 2 shows an exploded view of a first preferred embodiment of the present invention.

FIG. 3 shows a schematic view of the first preferred embodiment of the present invention in combination.

FIG. 4 shows a schematic view of the first preferred embodiment of the present invention in action.

FIG. 5 shows another schematic view of the first preferred embodiment of the present invention in action.

FIG. 6 shows an exploded view of a second preferred embodiment of the present invention.

FIG. 7 shows a schematic view of the second preferred embodiment of the present invention in combination.

FIG. 8 shows a schematic view of the second preferred embodiment of the present invention in action.

FIG. 9 shows another schematic view of the second preferred embodiment of the present invention in action.

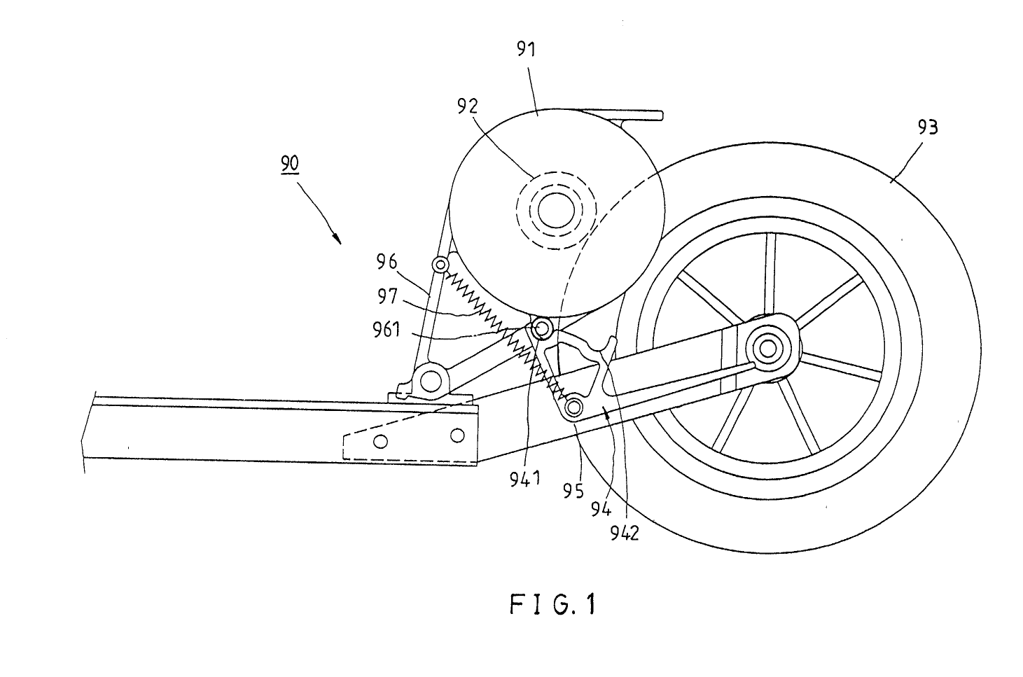

### DETAILED DESCRIPTION OF THE INVENTION

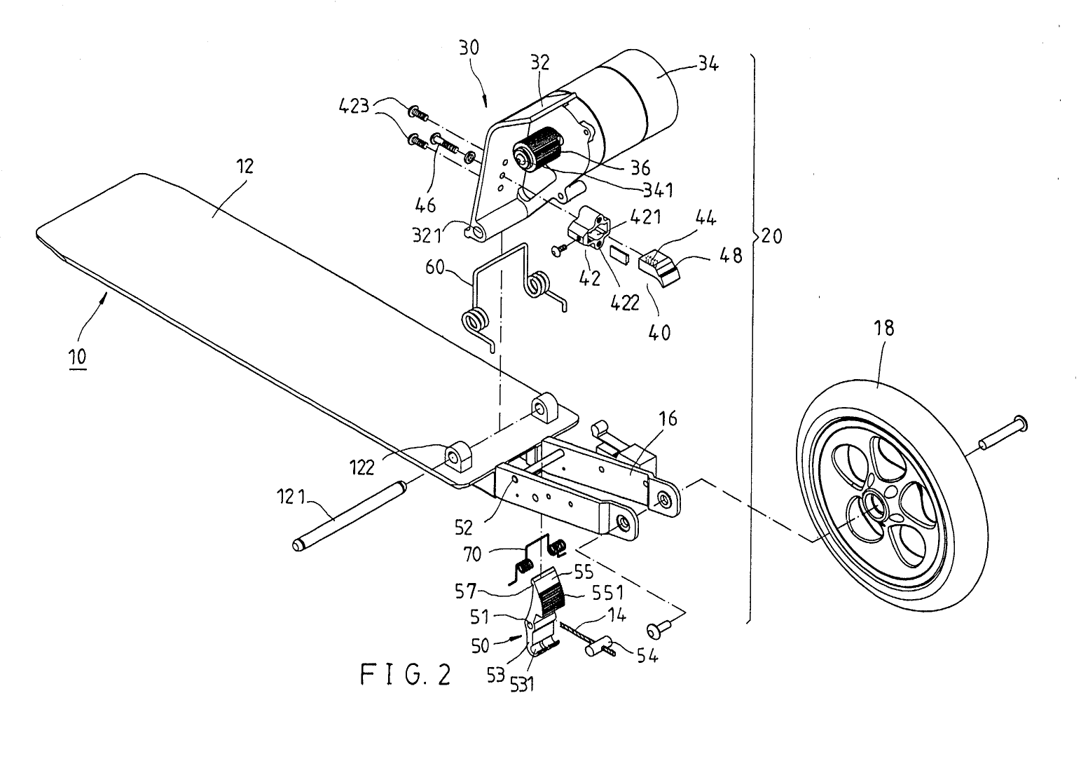

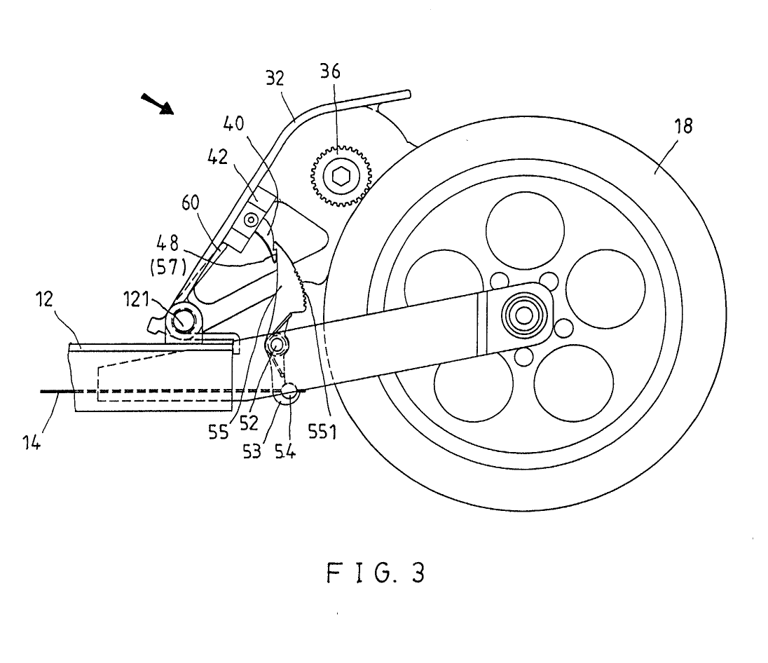

As shown in FIGS. 2-3, a cruise control device 20 of the first preferred embodiment of the present invention is mounted on a scooter 10 which is similar in construction with the prior art scooter. The cruise control device 20 comprises a long bottom board 12, a handlebar support (not shown in the drawing) pivoted to the front end of the bottom board 12. The handlebar support is provided with a grip having a brake lever (not shown in the drawing). The brake lever is connected with a brake cable 14. A front wheel (not shown in the drawing) is pivoted to the bottom end of the handlebar support. A rear fork 16 is extended from the rear end of the bottom board 12. A rear wheel 18 is pivoted to the rear fork 16. The device 20 is mounted on the rear fork 16 near the rear wheel 18 and is formed of a power unit 30, a joining member 40, and a retaining member 50.

The power unit 30 comprises a suspension seat 32 which is pivoted by a pivot 121 with two lugs 122 of the bottom board 12. The lugs 122 is provided therebetween with a torsion spring 60 to prevent the suspension seat 32 to swivel toward the rear wheel 18 under the normal state. A motor 34 is fastened with the suspension seat 32. A drive wheel 36 is mounted on an output shaft 341 of the motor 34 such that the drive wheel 36 engages the rear wheel 18 to drive the rear wheel 18.

The joining member 40 is received in a receiving cell 421 of a locating block 42 which is fastened with the suspension seat 32 by two bolts 423 engaging two threaded holes 422 of the locating block 42. The center of the joining member 40 is provided with a threaded hole 44 which is engaged with a bolt 46. The joining member 40 is provided at one end with an arcuate joining portion 48 extending out of the receiving cell 421.

The retaining member 50 is provided in the middle with a round hole 51 for pivoting the retaining member 50 with the rear fork 16 in conjunction with a torsion spring 70 and a shaft 52. The retaining member 50 is provided at one end with an actuating portion 53, and at other end with a brake 55. The actuating portion 53 is provided at the tail end with a cavity 531 for receiving a fastening member 54 of the brake cable 14. As the brake cable 14 is pulled, the retaining member 50 is actuated to swivel. The brake 55 has an arcuate brake surface 551 having a plurality of grains formed by a plurality of parallel grooves. The brake 55 is provided at the top end with a retaining portion 57 projecting in the direction opposite to the arcuate direction of the brake surface 551. The torsion spring 70 provides a recovery force enabling the retaining member 50 to return to its initial position at the time when the brake cable 14 is let go.

As shown in FIG. 3, the suspension seat 32 is pressed by foot to cause the joining portion 48 of the joining member 40 to join with the retaining portion 57 of the retaining member 50. The drive wheel 36 is in contact with the rear wheel 18, which is driven by the power of the motor 34 at a constant speed.

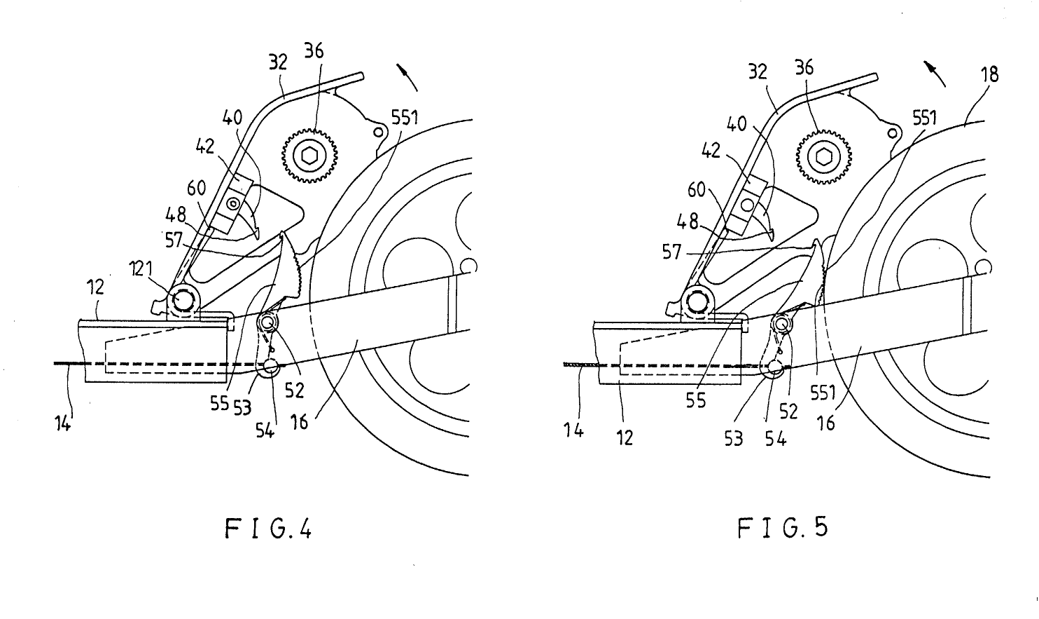

When the brake cable 14 is triggered, the actuating portion 53 is activated to cause the brake 55 to move toward the rear wheel 18. Because of the movement of the retaining portion 50, the retaining portion is disengaged with the joining portion 48. The suspension seat 32 is forced by the recovery force of the spring 60 to return to its original position, as shown in FIG. 4. The power is interrupted. By applying the brake surface 551, the rear wheel 18 in motion is stopped, as shown in FIG. 5.

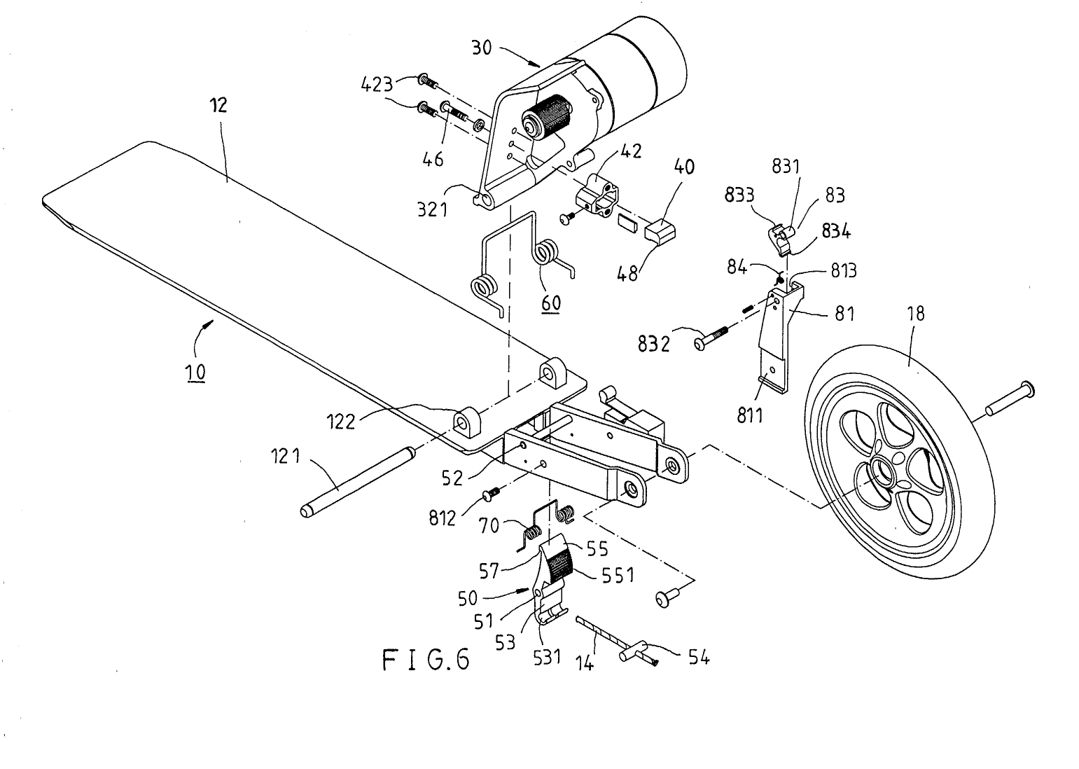

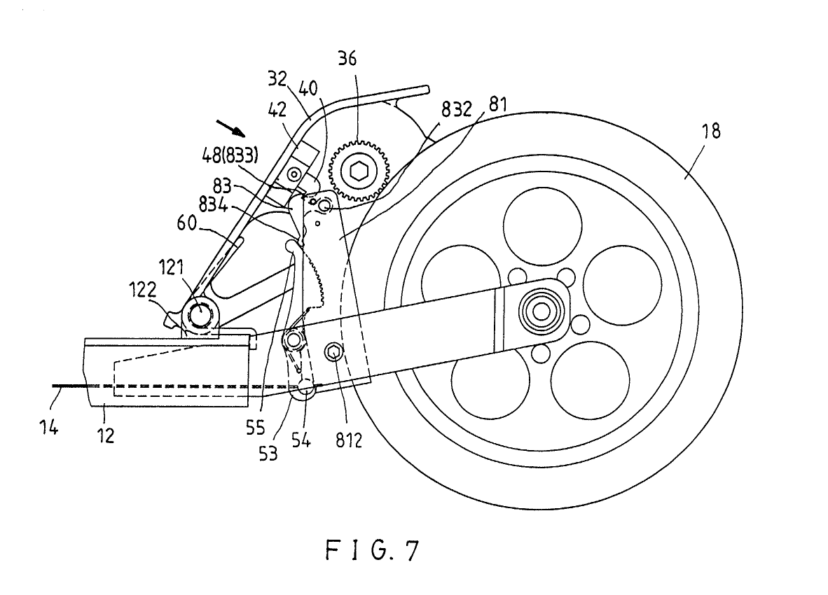

As shown in FIG. 6, the second preferred embodiment is different from the first preferred embodiment in that a support arm 81 is provided at the lower end with a flat plate portion 811 which is fastened by the fastening element 812 with the rear fork 16 of the scooter 10. The support arm 81 is provided at the upper end with a U-shaped space 813 for receiving a link block 83 which is provided in the middle with a shaft tube 831. The link block 83 is pivoted by a pivot 832 in the space 812. A torsion spring 84 is disposed at one end on the pivot arm 81 and is rested at other end on the link block 83 for providing a recovery force. The link block 83 is provided at the upper end with a retaining portion 833 of a recessed construction for joining with the joining portion 48 of a hooked construction. The link block 83 is provided at the lower end with a moving portion 834 which is located on the retaining member 50. As the suspension seat 32 is pressed by foot, the joining portion 48 is joined with the retaining portion 833 of the link block 83. The drive wheel 36 of the power unit 30 is in contact with the rear wheel 18, which is driven to move by the power of the motor 34 at a constant speed, as shown in FIG. 7.

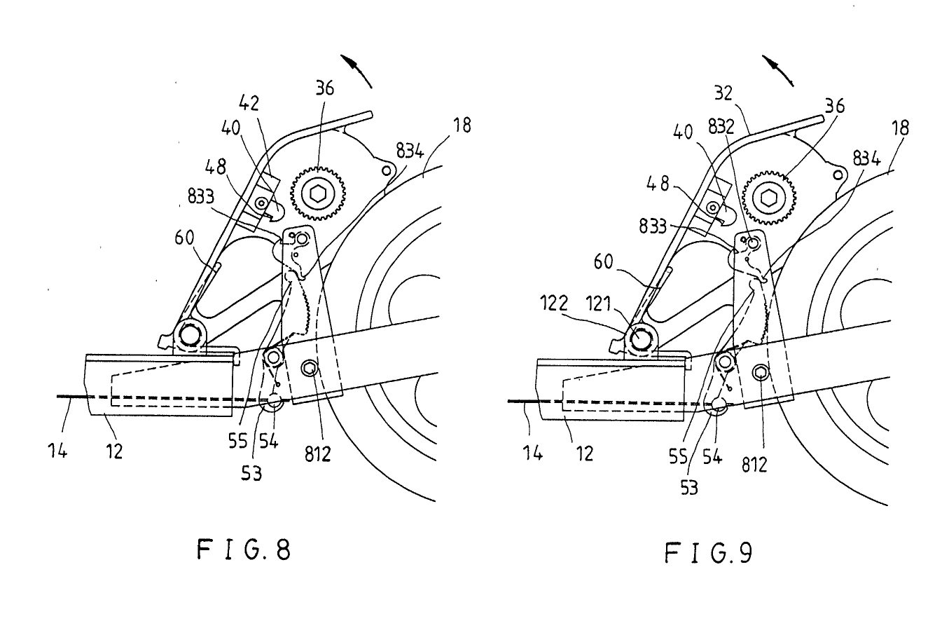

As the actuating portion 53 of the retaining member 50 is actuated, the brake 55 moves to touch the moving portion 834 of the link block 80, thereby causing the retaining portion 833 to move away from the joining portion 48. The suspension seat 32 is forced by the spring to return to its original position, as shown in FIG. 8. The drive wheel 36 is thus separated from the rear wheel 18. By applying the brake 55, the rear wheel 18 is stopped by friction, as shown in FIG. 9.

The joining member 40 may be made integrally with the suspension seat 32, without being fastened by the locating block 42. The actuating portion of the retaining member may be connected with the steel cable in conjunction with an operation handle. The brake cable may be fastened with the actuating portion of the retaining member without the use of the fastening member.

What is claimed is:

1. A cruise control device of an electric scooter, comprising:
a power unit having a suspension seat pivoted with the scooter bottom board such that said suspension seat is near a rear wheel, a motor mounted on said suspension seat, and a drive wheel mounted on an output shaft of the motor for driving the rear wheel, said suspension seat being acted on by an elastic member to separate the driven wheel from the rear wheel by a distance;
a joining member disposed at one end on said power unit and provided at other end with a joining portion;
a retaining member pivoted at midsegment with the scooter rear fork and provided at one end with an actuating portion which is connected with a steel cable of a handle such that said actuating portion turns on a midsegment thereof acting as an axis, said retaining member being acted on by an elastic member for forcing said retaining member to return to its original position, said actuating portion provided at one end with a retaining portion capable of joining with said joining portion of said joining member;
said suspension seat being pressed to cause said retaining portion to join with said joining portion, thereby causing said drive wheel to be in contact with said rear wheel so as to drive said rear wheel at a constant speed, said actuating portion being acted on to swivel by said steel cable so as to cause said retaining portion to disengage said joining portion, thereby causing said drive wheel to move away from said rear wheel.

2. The device as defined in claim 1, wherein said said suspension seat is provided with a locating block opposite to one side inner edge of said rear wheel, said locating block having a receiving cell for receiving said joining member such that a protruded portion of said joining member is jutted out of said receiving cell.

3. The device as defined in claim 1, wherein said retaining portion is provided in midsegment with a brake surface which is actuated by said cable to move toward said rear wheel when said retaining portion is disengaged with said joining portion, thereby resulting the rear wheel to be pressed against by said brake surface.

4. The device as defined in claim 3, wherein said brake surface is of an arcuate construction.

5. The device as defined in claim 1, wherein said steel cable is connected at other end with a brake lever of the scooter.

6. The device as defined in claim 1, wherein said retaining portion and said joining portion are provided therebetween with a link block which is pivoted at midsegment with a support arm of the scooter rear fork and is provided at the upper end with a retaining portion engageable with said joining portion of said joining member, and at the lower end with a moving portion in contact with said joining portion.

7. The device as defined in claim 6, wherein said support arm is fastened at the lower end with the scooter rear fork and is provided at the upper end with a U-shaped space for pivoting said link block.

8. The device as defined in claim 1, wherein said elastic member is a torsion spring for separating said drive wheel from said rear wheel by a distance.

9. The device as defined in claim 1, wherein said elastic member is a torsion spring for forcing said retaining member to return to its original position.
